(19) United States
(12) Patent Application Publication
(10) Pub. No.: US 2021/0166204 A1
(43) Pub. Date: Jun. 3, 2021

(54) CHARGING SYSTEM AND CHARGING METHOD

(71) Applicant: CANON KABUSHIKI KAISHA, Tokyo (JP)

(72) Inventor: Seiji Ogawa, Tokyo (JP)

(21) Appl. No.: 17/105,317

(22) Filed: Nov. 25, 2020

(30) Foreign Application Priority Data
Nov. 28, 2019 (JP) 2019-215445

(51) Int. Cl. G06Q 20/08; G06Q 20/12; A63F 13/655

(52) U.S. Cl. CPC G06Q 20/085; H04N 5/2251; A63F 13/655; G06Q 20/123

(57) ABSTRACT

A charging system includes a server that manages an image capturing mission uploaded by a user, a communication unit that communicates with a communication terminal having an image capturing function, an acquisition unit that acquires information indicating that an image capturing mission downloaded by the communication terminal is achieved by the communication terminal via the communication unit, and a calculation unit that calculates a charging amount charged to a system user who has uploaded the image capturing mission based on the number of image capturing missions achieved by the communication terminal, which is determined based on the information acquired by the acquisition unit.

### BACKGROUND

### Field

The present disclosure relates to a technique that manages content uploaded by a system user in a server and charges a fee to the system user depending on a usage state of the content.

### Description of the Related Art

Conventionally, a content providing system that provides content such as a game and an educational material to a user via the internet has been provided. The system is specifically designed to encourage the user to continuously use the system by frequently updating the content.

In the area of imaging capturing, because a user of an image capturing apparatus such as a digital camera has to personally look for an object as an image capturing target, sometimes it can be difficult for the user to maintain enthusiasm for capturing an image. As one solution, there is provided a method employing a gaming element of the content, which prompts a user to continuously use a camera by providing assignment content relating to image capturing (hereinafter, called “image capturing mission”) to the user from the camera.

In the system using the above-described method, a business model that makes a profit from an advertising effect of the content (image capturing mission) in addition to making a profit from distribution of image capturing apparatuses can be considered. For example, by distributing an image capturing mission that can only be achieved by capturing an image at a specific location, an effect of attracting customers to that specific location can be expected. For example, if a business partner (alliance partner) that manages an amusement park uses the system in order to acquire an advertising effect, a system usage fee can be collected from the alliance partner.

Generally, in the above-described system, such a business model will not work unless an appropriate amount of system usage fee is charged to the alliance partner. Therefore, it is important to set a system usage fee satisfactory to both the alliance partner (system user) and the system provider.

Japanese Patent Application Laid-Open No. 2001-216416 discusses a technique of increasing an advertising/promotion effect by providing a participatory game that makes a user enthusiastically browse an advertising page displayed on an advertising site of the internet. Specifically, according to the technique discussed in the above document, the advertising cost charged to the alliance partner is determined by calculating the advertising effect depending on the number of participants of the game.

Because “the number of participants of the game” in the business model discussed in Japanese Patent Application Laid-Open No. 2001-216416 merely corresponds to “the number of users who have installed the image capturing mission” in the above-described image capturing system, it is uncertain whether the advertising/promotion effect can be increased by simply installing the image capturing mission. Therefore, if the system usage fee is determined depending on the number of participants of the game as discussed in Japanese Patent Application Laid-Open No. 2001-216416, there is a possibility that the alliance partner (system user) cannot experience a sense of satisfaction.

### SUMMARY

According to an aspect of the present disclosure, charging system includes a server configured to manage an image capturing mission uploaded by a user, a communication unit configured to communicate with a communication terminal having an image capturing function, an acquisition unit configured to acquire information indicating that an image capturing mission downloaded by the communication terminal is achieved by the communication terminal, and a calculation unit configured to calculate a charging amount charged to a user who has uploaded the image capturing mission based on the number of image capturing missions achieved by the communication terminal, which is determined based on the acquired information.

Further features will become apparent from the following description of exemplary embodiments with reference to the attached drawings.

### BRIEF DESCRIPTION OF THE DRAWINGS

FIGS. 1A and 1B are diagrams illustrating external views of a camera according to an exemplary embodiment.

FIG. 2 is a functional block diagram illustrating a configuration of the camera according to an exemplary embodiment.

FIG. 3 is a schematic diagram illustrating a system configuration according to an exemplary embodiment.

FIGS. 4A to 4G are flowcharts illustrating control of respective apparatuses according to an exemplary embodiment.

FIGS. 5A to 5F are diagrams illustrating display examples of the camera according to an exemplary embodiment.

FIGS. 6A to 6E are diagrams illustrating display examples of a smartphone according to an exemplary embodiment

### DESCRIPTION OF THE EMBODIMENTS

An exemplary embodiment will be described below in detail with reference to the appended drawings.

The exemplary embodiment described below is merely an example for implementing the present disclosure, and can be modified or changed as appropriate depending on a configuration or various conditions of an apparatus to which the present disclosure is applied.

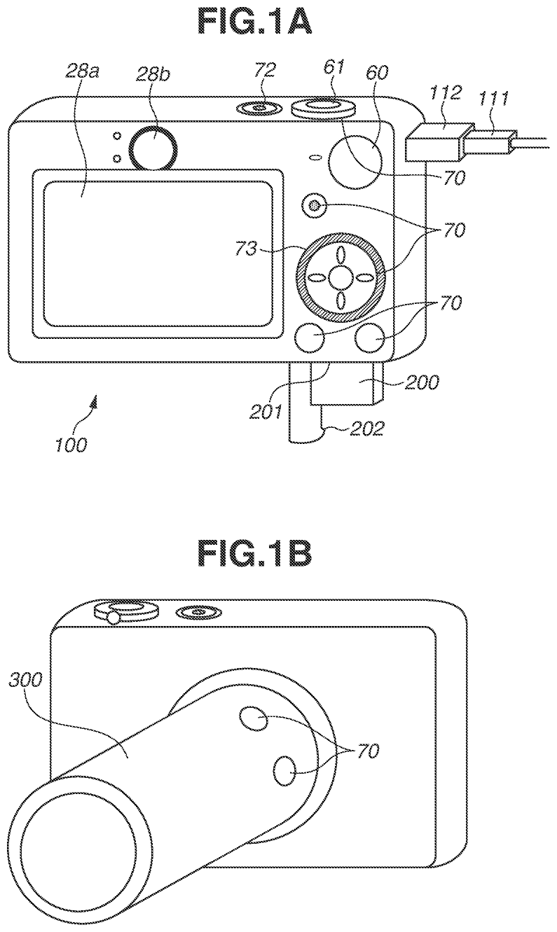

FIGS. 1A and 1B are diagrams illustrating external views of a camera according to the exemplary embodiment. FIGS. 1A and 1B respectively illustrate external views seen from a side of a photographer (i.e., rear face side) and a side of an object (i.e., front face side).

A camera (also called “digital camera”) 100 includes a display unit 28 for displaying a captured image and information about various settings relating to image capturing operation. The display unit 28 includes a rear face display panel 28a and an electronic viewfinder 28b, and display thereof is shifted based on the operation.

The camera 100 includes various operation units. A shutter button 61 arranged on an upper face of the camera 100 is an operation unit for receiving an image capturing instruction. A mode shifting switch 60 arranged on a rear face thereof is an operation unit for shifting an image capturing mode. An operation unit 70 includes operation members such as various switches, buttons, and a touch panel for receiving various types of operation from a user. A controller wheel 73 included in the operation unit 70 is an operation member that can be operated rotationally.

A power switch 72 arranged on the upper face of the camera 100 is a push button for switching the power of the camera 100 between ON and OFF. A connection cable 111 for connecting the camera 100 to an external apparatus such as a personal computer or a printer is attached to a connector 112 arranged on a side face of the camera 100.

A recording medium slot 201 for storing a recording medium 200 such as a memory card or a hard disk is arranged on a lower face of the camera 100. When the recording medium 200 is stored in the recording medium slot 201, the recording medium 200 can communicate with the camera 100, so that an image can be recorded in the recording medium 200, and an image recorded in the recording medium 200 can be reproduced by the camera 100. A cover 202 covers the recording medium slot 201. FIG. 1A illustrates a state where the cover 202 is opened and a part of the recording medium 200 is removed from the recording medium slot 201 and exposed therefrom.

A lens barrel 300 is arranged on a front face of the camera 100, and a part of the operation unit 70 is arranged on a side face of the lens barrel 300. The user can operate the camera 100 by using the operation unit 70 arranged on the side face of the lens barrel 300.

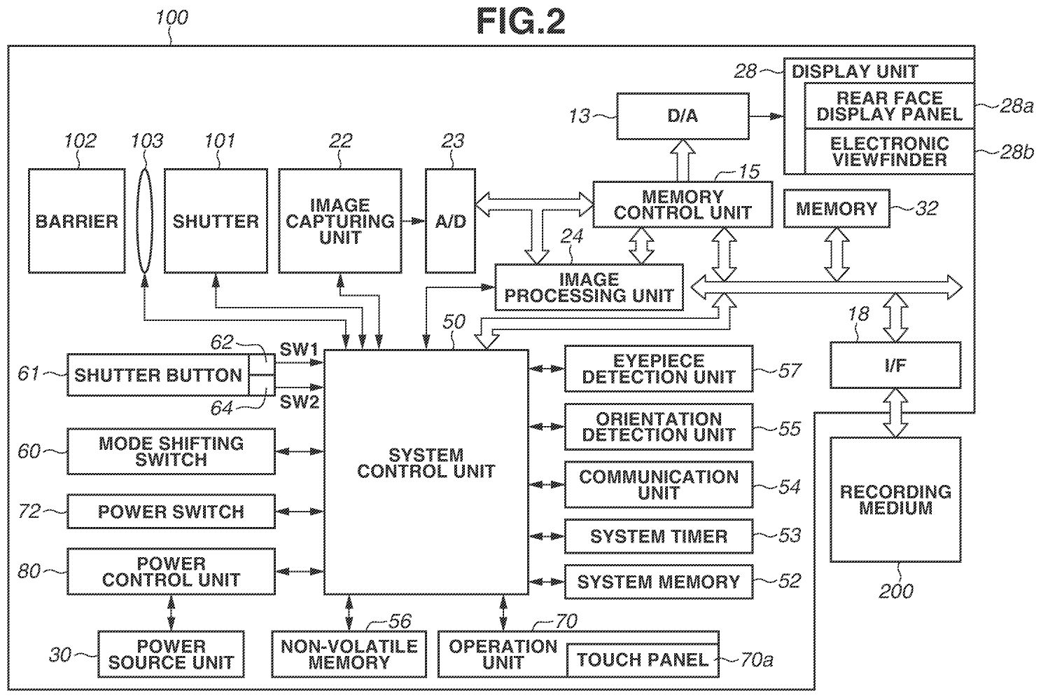

FIG. 2 is a block diagram illustrating a configuration example of the camera 100 according to the present exemplary embodiment.

In FIG. 2, an imaging lens 103 is a lens group that includes a zoom lens and a focus lens. A shutter 101 is a shutter having an aperture function. An image capturing unit 22 is an image sensor configured of a charge coupled device (CCD) or a complementary metal-oxide semiconductor (CMOS) element that converts an optical image into an electric signal. An analog-to-digital (A/D) converter 23 converts an analog signal output from the image capturing unit 22 to a digital signal. A barrier 102 covers members of an image capturing system of the camera 100 including the imaging lens 103, the shutter 101, and the image capturing unit 22 to prevent the respective members from being contaminated or damaged.

An image processing unit 24 executes resizing processing and color conversion processing such as pixel interpolation and reduction on data output from the A/D converter 23 and the memory control unit 15. Predetermined calculation processing is executed by the image processing unit 24 by using captured image data, and exposure processing and range finding control are executed by a system control unit 50 based on the acquired calculation result. With this configuration, autofocus (AF) processing, autoexposure (AE) processing, and electronic flash (EF) pre-emission processing using a through-the-lens (TTL) method are executed. The image processing unit 24 also executes predetermined calculation processing by using the captured image data, and executes auto-white balance (AWB) processing using the TTL method based on the acquired calculation result.

Data output from the A/D converter 23 is written into a memory 32 via the image processing unit 24 and the memory control unit 15, or via the memory control unit 15. The memory 32 stores image data that is acquired by the image capturing unit 22 and converted into digital data by the A/D converter 23 and image data that is to be displayed on the display unit 28. The memory 32 has a storage capacity sufficient for storing a predetermined number of still images and a predetermined period of a moving image and audio data.

The memory 32 also serves as an image-display memory (video memory). A digital-to-analog (D/A) converter 13 converts image-display data stored in the memory 32 into an analog signal and supplies the analog signal to the display unit 28. In this way, image data used for displaying an image, which is written into the memory 32, is displayed on the display unit 28 via the D/A converter 13. In addition, the digital signals converted by the A/D converter 23 and accumulated in the memory 32 are converted into analog signals by the D/A converter 13 and sequentially transferred to and displayed on the display unit 28, so that the display unit 28 can execute live-view display.

A non-volatile memory 56 is a memory capable of electrically recording and deleting data. A memory such as an electrically erasable programmable read-only memory (EEPROM) is used as the non-volatile memory 56. The non-volatile memory 56 stores a constant number for operating the system control unit 50 and a program. Herein, the program includes a computer program for executing various flowcharts described below.

The system control unit 50 controls the camera 100. The system control unit 50 executes the program stored in the non-volatile memory 56 to implement respective pieces of processing described below. The system memory 52 is a random access memory (RAM) used for loading a constant and a variable for operating the system control unit 50, and a program read from the non-volatile memory 56. The system control unit 50 can execute display control by controlling the memory 32, the D/A converter 13, and the display unit 28.

A system timer 53 is a timer unit that measures time used for various types of control and time of a built-in clock.

The mode shifting switch 60, the shutter button 61, and the operation unit 70 are operation units for inputting various operation instructions to the system control unit 50. By operating the mode shifting switch 60, the user can shift the operation mode of the system control unit 50 to any one of a still image recording mode, a moving image capturing mode, or a reproduction mode.

A first shutter switch 62 is turned ON and generates a first shutter switch signal SW1 when the user inputs an image capturing preparation instruction by halfway pressing the shutter button 61 arranged on the digital camera 100. The system control unit 50 starts executing the operation for the AF processing, the AE processing, the AWB processing, and the EF pre-emission processing when the first shutter switch signal SW1 is input thereto.

A second shutter switch 64 is turned ON and generates a second shutter switch signal SW2 when the user inputs an image capturing instruction by fully pressing the shutter button 61. The system control unit 50 starts executing the operation for a series of image capturing processing including processing for reading a signal from the image capturing unit 22 and writing image data to the recording medium 200 when the second shutter switch signal SW2 is input thereto.

A power control unit 80 includes a battery detection circuit, a direct current-to-direct current (DC-DC) converter, and a switching circuit for switching a block to be energized, and detects presence or absence of a mounted battery, a type of battery, and a remaining battery level are detected. Based on the detection result and an instruction from the system control unit 50, the power control unit 80 controls the DC-DC converter to supply required voltage to the respective units including the recording medium 200 for a necessary period.

A power supply unit 30 includes a primary battery such as an alkaline battery or a lithium battery, or a secondary battery such as a nickel-cadmium (NiCd) battery, a nickel-metal hydride (NiMH) battery, or a lithium-ion (Li) battery, and an alternating-current (AC) adapter. A recording medium interface (I/F) 18 serves as an interface between the camera 100 and the recording medium 200. The recording medium 200 is a recording medium such as a memory card for recording a captured image, configured of a semiconductor memory, an optical disk, or a magnetic disk.

A communication unit 54 is a communication interface for executing wireless or wired communication with an external apparatus. The communication unit 54 transmits and receives a video signal and an audio signal to/from the external apparatus. The communication unit 54 can also connect to a wireless local area network (LAN) and the internet. The communication unit 54 can transmit an image (including a live view image) captured by the image capturing unit 22 and an image recorded in the recording medium 200 to the external apparatus and receive image data and various types of information from the external apparatus.

An orientation detection unit 55 detects the orientation of the digital camera 100 in the gravitational direction. It is possible to determine whether the image captured by the image capturing unit 22 is an image captured by the digital camera 100 held in a horizontal orientation or a vertical orientation based on the orientation detected by the orientation detection unit 55. The system control unit 50 can attach direction information based on the orientation detected by the orientation detection unit 55 to an image file of the image captured by the image capturing unit 22 to rotate and record the image. An acceleration sensor or a gyroscope can be used as the orientation detection unit 55.

An eyepiece detection unit 57 detects an approaching eye (object) of the photographer. Depending on the state detected by the eyepiece detection unit 57, the system control unit 50 switches display and non-display of the rear face display panel 28a and the electronic viewfinder 28b.

The camera 100 can include a global positioning system (GPS) device (not illustrated) for acquiring a position of the camera 100. Attribute information such as the user's age can be input via the above-described operation members and stored in the camera 100. The content appropriate for the user can be distributed by using the above information for distributing an assignment content distributed by the external device such as a server apparatus described below or for outputting a captured image.

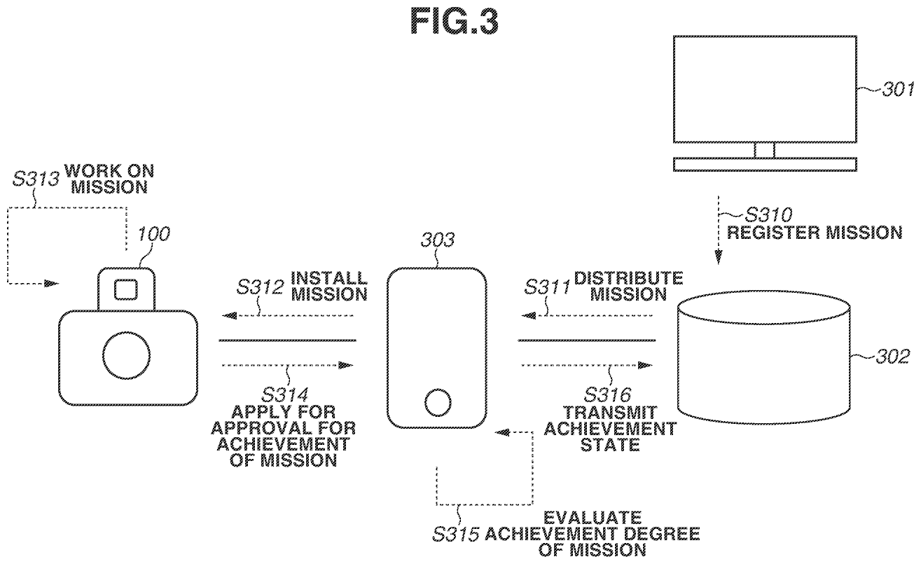

FIG. 3 is a conceptual diagram illustrating a configuration of a system according to the present exemplary embodiment. The system includes a digital camera 100, a smartphone 303 serving as a communication terminal, and a mission server 302 serving as a server that manages an image capturing mission. A personal computer (PC) 301 is a terminal operated by a system user. The terminals 301 and 303 can communicate with each other via a network.

The digital camera 100 provides a mission mode as one of the image capturing modes. When a camera user selects the mission mode by operating a mode selection dial, an image capturing mission is displayed on a display screen of the digital camera 100.

An application of the image capturing mission (i.e., mission application) is installed in the smartphone 303. The user operates the mission application and communicates with the digital camera 100 and the mission server 302 to transmit and receive data relating to the image capturing mission.

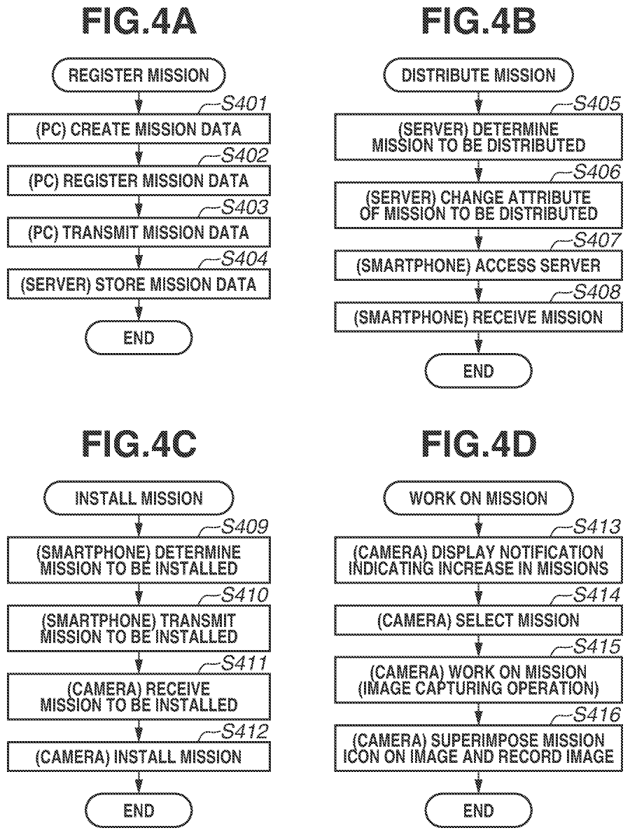

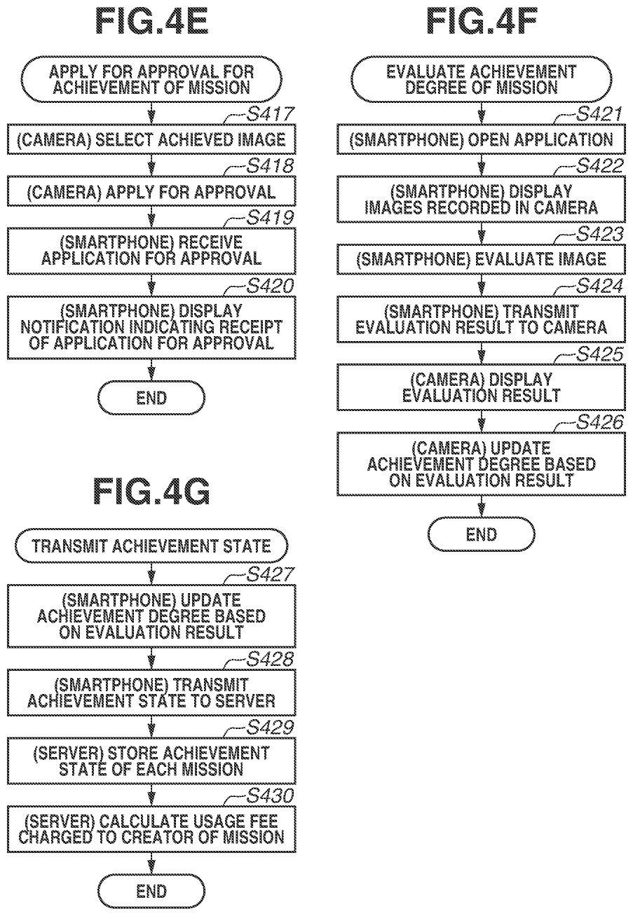

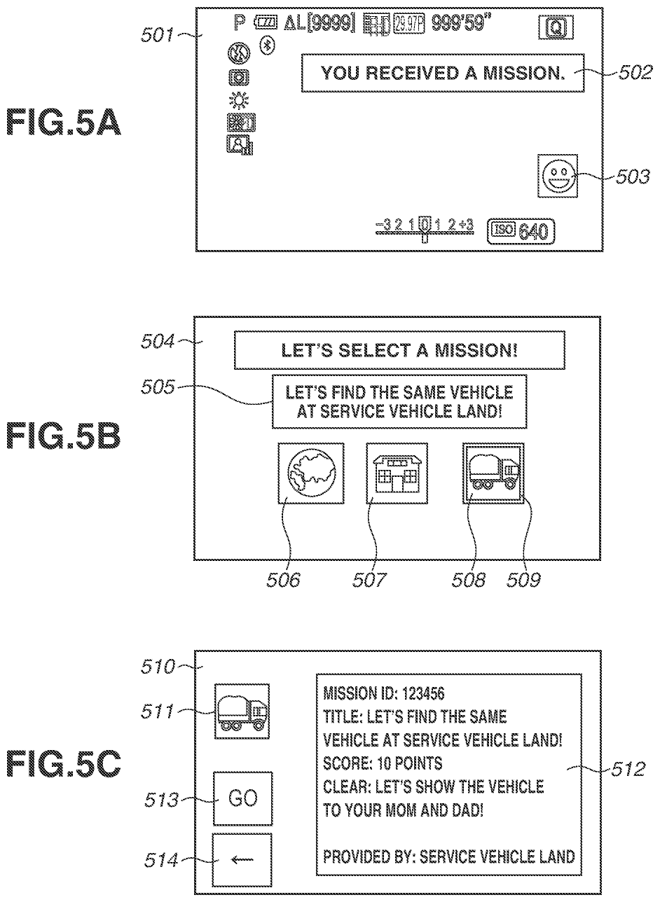

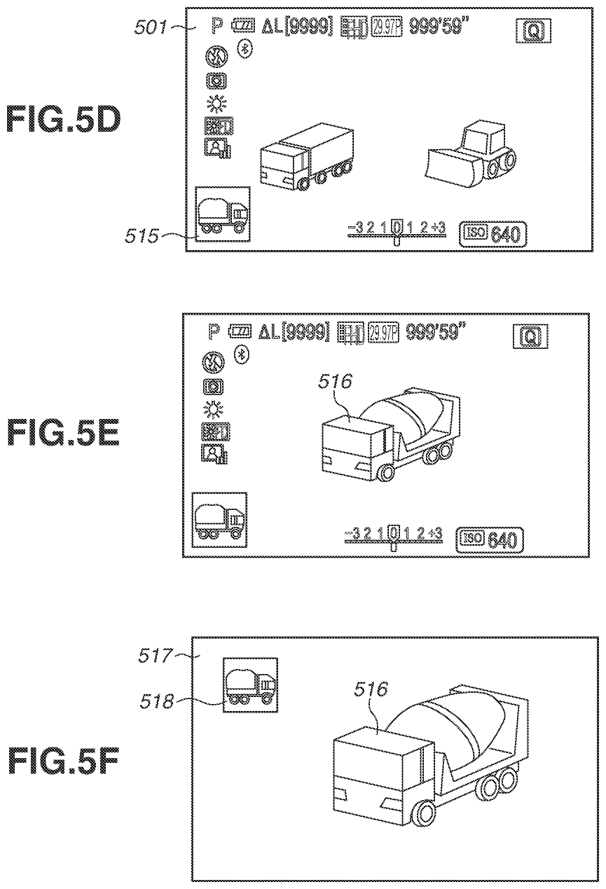

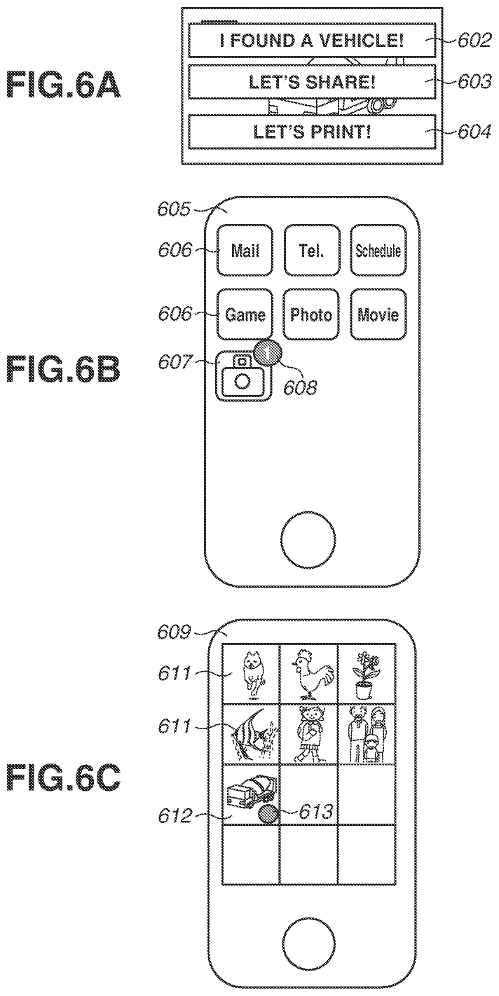

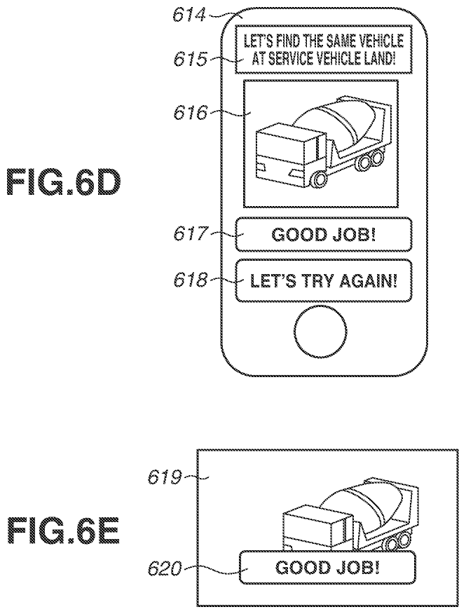

FIGS. 4A to 4G are flowcharts illustrating procedures of processing executed by each of the apparatuses. FIGS. 5A to 5F and FIGS. 6A to 6E are diagrams illustrating examples of screens displayed on the apparatuses when the image capturing mission is executed.

A series of processing including the processing for creating and registering (uploading) an image capturing mission, distributing (downloading) the image capturing mission, executing and evaluating the image capturing mission, and charging a fee to a system user will be described mainly with reference to FIG. 3 and FIGS. 4A to 4G. When the series of processing is described, a graphical user interface (GUI) displayed on each of the apparatuses will be described as appropriate with reference to FIGS. 5A to 5F and FIGS. 6A to 6E.

Turning to FIG. 3, in step S310, a system user creates an image capturing mission and registers the image capturing mission in the mission server 302 by using the PC 301. The registration processing of the image capturing mission in step S310 will be described in detail with reference to FIG. 4A.

Turning to FIG. 4A, in step S401, the PC 301 generates mission data based on the operation executed by the system user.

In step S402, the PC 301 stores the mission data based on the operation of the system user.

In step S403, the PC 301 transmits the mission data to the mission server 302 based on the operation of the system user.

In step S404, the mission server 302 receives the mission data transmitted from the PC 301 and stores the mission data in a storage area.

Returning to FIG. 3, in step S311, the mission server 302 distributes, to the smartphone 303 in which the mission application is installed, the image capturing mission periodically or at a timing when a condition for triggering the distribution of the mission is satisfied. The distribution processing of the mission executed in step S311 will be described in detail with reference to FIG. 4B.

Turning to FIG. 4B, in step S405, the mission server 302 determines a mission to be distributed based on the distribution condition previously set for each mission.

In step S406, the mission server 302 changes the data attribute of the mission to be distributed. For example, the data attribute is changed so that the smartphone 303 can confirm that the mission is released and downloadable via the mission application.

In step S407, the smartphone 303 receives a notification indicating that the attribute of the mission has been changed by the mission server 302, and displays a list of downloadable missions. The user operates the smartphone 303 to select a desired mission from among the missions displayed in the list.

In step S408, the smartphone 303 communicates with the mission server 302 to receive and store the mission data in the storage area.

Returning to FIG. 3, in step S312, the user of the smartphone 303 operates the smartphone 303 to install the mission distributed from the mission server 302 in the digital camera 100. The installation processing of the mission executed in step S312 will be described in detail with reference to FIG. 4C.

Turning to FIG. 4C, in step S409, based on the selection operation executed by the user, the smartphone 303 determines the mission to be installed in the digital camera 100.

In step S410, the smartphone 303 transmits the mission to be installed to the digital camera 100.

In step S411, the digital camera 100 receives the mission from the smartphone 303.

In step S412, the digital camera 100 installs the received mission.

Turning back to FIG. 3, in step S313, the user of the digital camera 100 uses the digital camera 100 to work on the installed mission. The mission is an assignment relating to image capturing, so that the user actually uses the digital camera 100 to capture an image according to the mission. The processing for working on the mission executed in step S313 will be described in detail with reference to FIG. 4D.

Turning to FIG. 4D, in step S413, when the mission is installed, the system control unit 50 of the digital camera 100 displays a notification indicating an increase in missions.

FIG. 5A is a diagram illustrating an example of a screen of the camera 100, displaying a notification indicating an increase in missions. For example, if the camera 100 is operating in a normal image capturing mode, a notification 502 indicating an increase in missions is superimposed and displayed on a live-view screen 501. A touch button 503 that enables the user to shift the image capturing mode to a mission mode can also be superimposed and displayed on the live-view screen 501. The image capturing mode is shifted to the mission mode when the user touches and operates the touch button 503, so that the live-view screen 501 is shifted to a mission selection screen. While the touch button is described as an example, a physical button can be used for shifting the live-view screen 501 to the mission selection screen.

Returning to FIG. 4D, in step S414, based on the user operation, the system control unit 50 of the digital camera 100 executes operation for selecting the mission.

FIG. 5B is a diagram illustrating an example of a mission selection screen displayed on the camera 100. A guidance that prompts the user to select a mission and a plurality of installed missions are displayed on a mission selection screen 504. In the display example illustrated in FIG. 5B, missions 506 to 508 are displayed. A cursor 509 indicates a currently selected mission. In this example, a mission 508 is displayed and surrounded by the cursor 509. A title or a category name 505 corresponding to the mission 508 is displayed on the mission selection screen 504, so that the user can find out the overview of the mission.

Herein, the mission 508 relates to a virtual amusement park called “Service Vehicle Land”. When the user executes determination operation in a state where the cursor 509 is adjusted to the mission 508, the mission selection screen 504 is shifted to a detail screen that displays the content of the mission.

FIG. 5C is a diagram illustrating an example of a mission detail screen. An icon 511 symbolizing the content of the mission and an explanatory text 512 explaining the content of the mission are displayed on a mission detail screen 510. In the present exemplary embodiment, an icon of a vehicle that symbolizes the mission is displayed because the mission relates to the Service Vehicle Land. When the user touches a determination button 513 displayed on the mission detail screen 510, the digital camera 100 is brought into a state where the mission is being carried out, so that the user can execute image capturing. When the user touches a cancel button 514, the mission detail screen 510 is shifted to the above-described mission selection screen 504.

Returning to FIG. 4D, in step S415, the user operates the digital camera 100 to capture an image based on the content of the mission. FIG. 5D is a diagram illustrating an example of a screen displayed on the digital camera 100 when the user is working on the mission. The digital camera 100 is brought into a state where image capturing can be executed, and an icon 515 indicating the content of the mission is displayed on the live-view screen 501 of the digital camera 100. Display of the icon 515 represents a state where the mission (i.e., selected mission 508) is being carried out. In this state, as illustrated in FIG. 5E, the user searches the amusement park for a vehicle 516 that is the same as the vehicle indicated by the mission icon and captures an image thereof.

In step S416, the system control unit 50 of the digital camera 100 superimposes the mission icon on the captured image and records the captured image. FIG. 5F is a diagram illustrating an example of a captured image stored in the digital camera 100. The vehicle 516 as a target object of the mission is included in a captured image 517. An icon 518 indicating the content of the mission is also superimposed and recorded on the captured image 517. In this way, when the user reproduces the captured image stored in the camera 100, the user can recognize which mission the reproduced image has been captured for.

Turning back to FIG. 3, in step S314, the user of the digital camera 100 applies for an approval for achievement of the mission to the smartphone 303. For example, an exemplary embodiment in which a child who has worked on a mission by using a digital camera transmits a result thereof to a parent and asks the parent to approve achievement of the mission can be considered. This processing for applying for an approval for achievement of the mission executed in step S314 will be described in detail with reference to FIG. 4E.

Turning to FIG. 4E, in step S417, from among the images recorded in the digital camera 100, the user operates the digital camera 100 to select an image for which the user wishes to receive an approval from the smartphone 303. FIG. 6A is a diagram illustrating a screen that enables the user to select content of approval with respect to the image as an approval request target. Pieces of request content 602 to 604 are displayed on the screen when the user executes operation for requesting an approval from the smartphone 303 in a state where a selected captured image 601 is displayed thereon. For example, the user can notify the smartphone 303 of achievement of the mission and request an approval by selecting the request content 602. By selecting the request content 603, the user can request a social network service (SNS) to register the image via the smartphone 303 in addition to requesting the approval. By selecting the request content 604, the user can request a printer to print the image via the smartphone 303 in addition to requesting the approval.

In step S418, as described above, the digital camera 100 transmits the application for approval based on the request content to the smartphone 303. The application for approval can be executed when the user touches any one of the pieces of request content 602 to 604 displayed on the screen in FIG. 6A.

In step S419, the smartphone 303 receives the application for approval.

In step S420, the smartphone 303 notifies the user of receipt of the application for approval by displaying a notification on the screen. FIG. 6B is a diagram illustrating an example of the notification. A standby screen of the smartphone 303 is displayed on the display unit 605, and icons 606 of a plurality of applications are arranged thereon. An icon 607 of the mission application is displayed as one of the icons 606. In this example, a notification icon 608 indicating receipt of the application for approval is displayed together with the icon 607 of the mission application.

Returning to FIG. 3, in step S315, the user of the smartphone 303 receives the application for approval and evaluates whether the mission is achieved to a degree that satisfies a predetermined standard. The processing for evaluating an achievement degree of the mission executed in step S315 will be described in detail with reference to FIG. 4F.

Turning to FIG. 4F, in step S421, the smartphone 303 executes the mission application based on the user operation.

In step S422, based on the user operation, the smartphone 303 displays a list of images recorded in the digital camera 100 associated with the smartphone 303 via the mission application. FIG. 6C is a diagram illustrating an example of the screen displaying the list. A plurality of thumbnails 611 is displayed on the display unit 609. If an image 612, which an approval thereof is requested, is included in the thumbnails, an icon 613 is superimposed and displayed on the image 612. Thus, the user can recognize that an approval is requested.

In step S423, based on the user operation, the smartphone 303 evaluates the image, approval for which has been requested, as to whether the mission is achieved to a degree that satisfies a predetermined standard. FIG. 6D is a diagram illustrating an example of an evaluation screen displayed on the smartphone 303. An image 616 as an evaluation target and content 615 of the mission are displayed on a display unit 614. Buttons 617 and 618, which the user of the smartphone 303 operates to determine approval or non-approval of the submitted image, are displayed on the display unit 614. The evaluation is completed when the user touches any one of the buttons 617 and 618.

In step S424, based on the user operation, the smartphone 303 transmits the evaluation result to the digital camera 100.

In step S425, the digital camera 100 displays the evaluation result. FIG. 6E is a diagram illustrating an example of a screen of the evaluation result displayed on the digital camera 100. In this example, an evaluation result 620 is superimposed and displayed on an image 619 as an evaluation target.

In step S426, based on the evaluation result, the digital camera 100 updates an achievement degree of each mission managed by the digital camera 100.

After the user executes evaluation via the smartphone 303, in step S316, the mission application transmits information about the achievement degree of the mission to the mission server 302. As a result, the mission server 302 shares an achievement state of each mission with the smartphone 303. The processing for acquiring the achievement state executed in step S316 will be described in detail with reference to FIG. 4G.

Turning to FIG. 4G, in step S427, based on a result of evaluation of the mission executed by the mission application, the smartphone 303 updates the achievement degree of each mission.

In step S428, the smartphone 303 transmits information about the achievement degree of each mission to the mission server 302.

In step S429, the mission server 302 stores the received achievement degree of the mission.

In step S430, the mission server 302 calculates an amount of a usage fee charged to the user who has created the mission depending on the number of achievements of the mission. The mission server 302 recognizes a terminal that downloads the mission for each of the missions, and acquires the achievement state of the mission from the terminal. Accordingly, the mission server 302 functions as a charging system that calculates a system usage fee depending on the number of achievements of the mission. For example, the mission server 302 calculates an amount of a usage fee to be higher when the number of achievements of the mission is greater.

As described above, when the image capturing mission is to search the Service Vehicle Land for a specific vehicle to capture an image of that vehicle, a user who has achieved the mission should be a visitor of the Service Vehicle Land. Accordingly, from a viewpoint of a system user (i.e., a business operator of the amusement park) who has created the image capturing mission, this image capturing mission has achieved a customer attracting effect proportionate to the number of achievements of the image capturing mission. Therefore, with the system usage fee that is priced depending on the number of users who have achieved the mission, the system user can experience a sense of satisfaction. In other words, for the system user who creates and registers the image capturing mission, the system usage fee is commensurate with the customer attracting effect, and thus the image capturing mission is an effective advertisement commensurate with cost.

In addition, priority of missions displayed on the smartphone 303 can be changed depending on the achievement degree of each of the missions. For example, by preferentially displaying a mission that has been achieved by only a small number of users, a customer attracting effect can be provided to a wide range of system users.

The mission server 302 can also acquire position information from the smartphone 303 and distribute a mission depending on the position of the user. For example, a mission can be registered to be distributed to a user who is visiting a specific facility such as a tourist site.

While the above-described mission is a mission that can be completed by one time of image capturing, the mission can be achieved by a plurality of times of image capturing or moving-image capturing. The mission server 302 can determine whether the mission is completed by one time of image capturing or a plurality of times of image capturing and change a calculation method of the charging amount depending on the determination result. Because the mission that is completed by a plurality of times of image capturing has a profound advertising effect, a charging amount can be set to be higher.

In the above-described exemplary embodiment, the user has to capture an image at a specific location in order to achieve the mission. However, the user can capture an image relating to a specific product. For example, there is a case where a system user such as a company that sells a specific product registers the image capturing mission. Specifically, a food manufacturer can distribute a mission prompting a customer to capture an image of food seasoned with seasonings manufactured by the food manufacture.

Evaluation of the achievement degree of the mission is typically manually executed by the user of the smartphone 303 by checking the submitted captured image. However, evaluation can be automatically executed by the mission application. In this case, the smartphone 303 requests the digital camera 100 to transmit parameters associated with image capturing operation together with the captured image to execute evaluation by using the following acquired parameters:
number of times of image capturing that the user has executed while looking at the rear face liquid crystal display
number of times of image capturing that the user has executed while looking into the electronic view finder
number of times the captured image is printed or transmitted to an external device
rating information attached to the captured image.

As a reward for achievement of the mission, service content can be distributed to the user who has achieved the image capturing mission. For example, in the case of a mission that the user has to capture an image at a specific location such as an amusement park, a coupon that offers a discount on the admission fee of a next visit can be distributed to the smartphone 303.

In the above-described exemplary embodiment, as illustrated in FIG. 3, the smartphone 303 interposes between the digital camera 100 and the mission server 302. However, the digital camera 100 and the mission server 302 can communicate with each other to directly transmit or receive the mission data.

While an exemplary embodiment has been provided, this exemplary embodiment is not seen to be limiting. Many variations that do not depart from the essential spirit of the present disclosure are applicable. A configuration in which the above-described exemplary embodiments are appropriately combined is also included in the scope of the present disclosure.

The above-described exemplary embodiment is described using a digital camera. The exemplary embodiment is not limited thereto, and any communication terminal having an image capturing function, such as a tablet PC, a personal digital assistance (PDA), or a mobile phone, etc., is applicable.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the aspect of the present disclosure, a system usage fee can be appropriately set for a system user who has uploaded content depending on an advertising effect of the uploaded content.

While exemplary embodiments have been described, these exemplary embodiments are not seen to be limiting. The scope of the following claims is to be accorded the broadest interpretation so as to encompass all such modifications and equivalent structures and functions.

This application claims the benefit of Japanese Patent Application No. 2019-215445, filed Nov. 28, 2019, which is hereby incorporated by reference herein in its entirety.

What is claimed is:

1. A charging system comprising:
a server configured to manage an image capturing mission uploaded by a user;
a communication unit configured to communicate with a communication terminal having an image capturing function;
an acquisition unit configured to acquire information indicating that an image capturing mission downloaded by the communication terminal is achieved by the communication terminal; and
a calculation unit configured to calculate a charging amount charged to a user who has uploaded the image capturing mission based on a number of image capturing missions achieved by the communication terminal, which is determined based on the acquired information.

2. The charging system according to claim 1, wherein the calculation unit calculates the charging amount to be higher as the number of image capturing missions achieved by the communication terminal is greater.

3. The charging system according to claim 1, wherein the calculation unit changes a calculation method for calculating a charging amount based on content of the image capturing mission.

4. The charging system according to claim 3, wherein the calculation unit determines whether the image capturing mission is a first mission completed by a single image capturing operation or a second mission completed by a plurality of image capturing operations and calculates a charging amount based on a determination result.

5. The charging system according to claim 1, wherein the acquisition unit acquires the information via a different communication terminal that communicates with the communication terminal.

6. The charging system according to claim 5, wherein the different communication terminal receives a captured image from the communication terminal and evaluates an achievement degree of an image capturing mission.

7. The charging system according to claim 6, wherein the different communication terminal receives a parameter of image capturing operation from the communication terminal and uses the parameter for the evaluation.

8. The charging system according to claim 1, wherein the image capturing mission is an assignment that is achieved by capturing an image at a specific location.

9. The charging system according to claim 1, wherein the image capturing mission is an assignment that is achieved by capturing an image of a specific object.

10. A charging method comprising:
managing an image capturing mission uploaded by a user;
communicating with a communication terminal having an image capturing function;
acquiring information indicating that an image capturing mission downloaded by the communication terminal is achieved by the communication terminal;
determining a number of image capturing missions achieved by the communication terminal based on the acquired information; and
calculating a charging amount charged to a user who has uploaded the image capturing mission based on the number of image capturing missions achieved by the communication terminal.

11. A non-transitory computer-readable storage medium storing a program causing a computer to execute a method, the method comprising:
managing an image capturing mission uploaded by a user;
communicating with a communication terminal having an image capturing function;
acquiring information indicating that an image capturing mission downloaded by the communication terminal is achieved by the communication terminal;
determining a number of image capturing missions achieved by the communication terminal based on the acquired information; and
calculating a charging amount charged to a user who has uploaded the image capturing mission based on the number of image capturing missions achieved by the communication terminal.
